(19) United States
(12) Patent Application Publication
(10) Pub. No.: US 2003/0117403 A1
(43) Pub. Date: Jun. 26, 2003

(54) System and method for operation optimization in hardware graphics accelerator for real-time rendering

(76) Inventors: Tae Joon Park, Taejon (KR); Soon Hyoung Pyo, Taejon (KR); Chang Woo Chu, Taejon (KR); Byoung Tae Choi, Taejon (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 10/067,321

(22) Filed: Feb. 7, 2002

(30) Foreign Application Priority Data
Dec. 24, 2001 (KR) 2001-84214

(51) Int. Cl. G06F 15/16; G06T 1/20

(52) U.S. Cl. 345/503

(57) ABSTRACT

The present invention relates to a system and method for operation optimization in a hardware graphics accelerator for real-time rendering, which optimizes operation number or sequence in the hardware graphics accelerator so as to improve the display speed of three-dimensional objects on a computer screen when the three-dimensional objects are displayed with the hardware graphics accelerator. The invention enables a high screen display speed by analyzing material properties of the 3-D objects prior to screen display and grouping triangles composing the 3-D objects according to the same material property to produce triangle groups as many as the material properties; sorting and managing the triangles in each of the groups according to the distance from a camera; and extracting one triangle most distanced from the camera from the each of the groups at the point of screen display and finally selecting one triangle most distanced from the extracted triangles and outputting the same, in which the triangles are so controlled that another triangle extracted from the same group as the selected triangle is continuously outputted unless the another triangle does not overlap with the triangle extracted from other group even after the selected triangle is displayed. Effective display state is maintained due to distance control from the camera and the state variation is minimized so that a high-speed display is enabled using the hardware graphics accelerator.

### BACKGROUND OF THE INVENTION

1. Field of the Invention

The present invention relates to a system and method for operation optimization in a hardware graphics accelerator for real-time rendering. In particular, the invention optimizes operation number or sequence in the hardware graphics accelerator so as to improve the display speed of three-dimensional objects on a computer screen when the three-dimensional objects are displayed with the hardware graphics accelerator.

2. Description of the Related Art

At present, a three-dimensional (3D) game service or web 3-D application service based upon a function of displaying 3-D objects on a screen at a high speed experiences rapid growth in demand, and demand for related application programs thereof is rapidly growing according to general growth of income level in the society and taste of the public wanting new amusement materials or multimedia contents.

In particular, as a high-performance graphics accelerator, e.g. graphics acceleration board, is basically mounted to a PC due to development of a hardware technology, a general PC came to execute high-speed triangle processing, which previously was executed only in an expensive special purpose graphics workstation or a video game machine. Therefore, demand for new application programs using the high-speed triangle processing is increasing while related study results and various commercial systems are being published.

Before the development of the graphic accelerator, the culling technique and the LOD technique were generally used for real-time display of 3-D objects. The culling technique reduces the number of triangles processed by an output device for screen display prior to operation of the device. The LOD technique controls the number of triangles composing the 3-D objects according to the area of the screen occupied by the objects after the objects are displayed.

However, these techniques were utilized at those times that the hardware graphic accelerators were not developed yet, and are accompanied with various restrictions about the number of triangles composing objects for screen display. Further, since a pre-treatment composed of sophisticated geometric operations is required in application of these techniques, it is not easy to use these techniques.

Hereinafter, in reference to FIG. 1, it will be described about conventional methods utilized for outputting a 3-D object on a computer screen in real-time such as the culling technique and the LOD technique.

FIG. 1 illustrates a process of reducing the number of triangles processed in a display device according to the conventional LOD technique and the culling technique.

Referring to FIG. 1, geometric information and material property information of a 3-D object is primarily processed by an LOD controller 10, by which the geometric structure of the object is changed according to the size that the displayed object occupies in a screen. If the object occupies the screen at a low ratio, the object will be composed of a small number of triangles. On the contrary, at a high ratio, the number of the triangles composing the object will be large.

In succession, a geometric model restructured as above is converted into the form of a triangle list, which is necessarily displayed, through a culling controller 20. The triangle list is displayed on the screen via a display device 30. Gains in the display speed can be obtained by displaying the triangles on the screen after applying the LOD and culling techniques thereto rather than displaying all of the triangles based upon the initially given geometric information because the number of the triangles to be processed by the display device is obviously reduced.

FIG. 2A illustrates an operation structure of the foregoing LOD technique for explaining a controlling method of the LOD controller 10 shown in FIG. 1.

The LOD technique changes precision for expressing the 3-D object according to the size that the 3-D object is displayed on the screen. For example, if an object composed of about 3000 triangles is projected into about 10 pixels in a real image, i.e. too many vertices are projected into one pixel so that the object does not appear clearly, the display device tends to perform too many calculations for the display quality of the image.

In order to overcome the problem, the LOD technique uses objects having gradient LOD, and projects a low LOD model into a screen in respect to an object which is distanced away from a view point and thus appears small in the screen while projecting a high LOD model, i.e. a model expressed in high detail, into the screen in respect to an object which is adjacent to the view point and thus necessarily expressed in detail.

The LOD technique includes a method of continuously changing the number of vertices of an object in real-time and a method of composing an object such as mirror into a number of objects having various LOD and selecting them at the point of display.

In general, the continuous LOD technique is frequently applied to the height map type topology. Whereas the technique of selecting among the several pre-composed models is used for other objects because the other objects occasionally undergo distortion of texture if applied with the continuous LOD technique. When the selective technique is used, however, the LOD of the object is abruptly changed thereby occasionally resulting in a popping on the screen.

The LOD technique shown in FIG. 2A illustrates an operation structure of the continuous LOD technique. The LOD technique comprises: displaying a given 3-D object on a screen by processing the geometric information and the material property information of the given 3-D object according to camera information; determining a ratio appearing on the screen; and controlling the number of triangles composing the 3-D object via an edge collapse 11, an edge split 12 and an edge removal 13. The LOD controller outputs the geometric information and the material property information, which are simplified according to the screen-occupying ratio via the edge collapse 11, edge split 12 and edge removal 13, into a culling controller 20.

FIG. 2B illustrates a culling technique using the culling controller 20 shown in FIG. 1.

As shown in FIG. 2B, in order to display an environment composed of 3-D objects into a scene viewed from an arbitrary position, all of the objects in the 3-D environment are projected into an image plane via a process of perspective projection or orthographic projection. This process multiplies each vertex into rotation, translation and projection matrices, in which it is inefficient to calculate all of the objects which are not displayed in the real image.

Therefore, the image can be more rapidly displayed by pre-determining those objects which have high probability to be drawn on the screen in the view point of a camera at present; and performing a projection process to those objects only. Such a process of determining the necessary objects prior to the projection process is called culling.

The culling process comprises a view frustum culling 21, a back-face culling 22 and a hidden-surface culling 23. These three culling processes 21 to 23 operate in a mutually complementary manner to select a 3-D triangle list, which is necessarily displayed about the given camera information, from the entire triangles. As a result, upon receiving the geometric information and the material property information simplified according to the screen-occupying ratio outputted from the LOD controller 10, the culling controller 20 outputs the 3-D triangle list to be outputted via a display device 30 through the view frustum culling 21, the back-face culling 22 and the hidden-surface culling 23.

Now the foregoing culling techniques will be described in more detail in reference to FIGS. 3A to 3C.

FIG. 3A illustrates a process of the view frustum culling in the culling techniques.

View frustum means “view point of camera”, and the view frustum technique is a conceived from the fact that the display device need not control those objects appearing at edges of a screen produced when displayed on the screen. For the purpose of this, a given 3-D environment is composed using a spatial division technique such as an oct-tree or a BSP-tree.

FIG. 3B illustrates a process of the back-face culling in the culling techniques.

This technique is conceived from the fact that only those faces looking toward the camera are shown on the screen while those faces looking away from the camera are not shown on the screen in drawing a tangible object existing in a 3-D space. In order to apply this technique, the angles between normal vectors of faces composing the 3-D object and a camera view direction vector are necessarily inspected, and triangles are previously classified according to their normal vectors.

FIG. 3 illustrates a process of the hidden-surface culling in the culling techniques.

The hidden-surface culling technique is conceived from the fact that the display device need not control an object if it can be previously confirmed that the object is completely covered by another object when at least two objects are displayed on the screen at the same time. Applying the hidden-surface culling also requires a technique for grasping sequential relation between the two objects in a rapid and precise fashion.

For the above technique, a method of triangle extraction is frequently used, in which a BST-tree is composed about the given 3-D objects to compose the 3-D objects according to the distance from the camera.

Every time, the BST-tree divides the entire space into two spaces based upon one plane. The separately divided spaces are recursively subjected to the same division. As a result, each leaf node of the BSP-tree is allocated with one exclusive separated space, leaving a set of polygons which can be simply rendered into the space.

When the culling or LOD technique is utilized as above, load of the hardware device can be reduced by previously selecting those triangles necessarily appearing on the screen of the whole triangles composing the entire 3-D objects and transmitting the selected triangles into a hardware device, thereby enhancing a display speed of the device.

However, such a technique utilized before the development of the graphic accelerator is required to undergo a very sophisticated and time-consuming pre-treatment step and cannot compose the 3-D objects with a large number of triangles for effective processing.

Meanwhile, the hardware graphics accelerator which can be frequently seen in the PC due to the development of the latest hardware technology internally employs a Graphics Processing Unit (GPU) in order to process a number of triangles at a high speed. Such a graphics accelerator has its own internal operation circuit and is operated according to a self-pipelining, and thus can operate at a very high speed if the continuance of internal operation is maintained while the state variation is minimized from the outside

### SUMMARY OF THE INVENTION

Accordingly the present invention has been made to solve the foregoing problems of the prior art and it is an object of the invention to provide a system and method of operation optimization in a hardware graphics accelerator for real-time rendering, which optimizes operation number or sequence in the hardware graphics accelerator so as to improve the display speed of a three-dimensional object on a computer screen when the three-dimensional object is displayed with the hardware graphics accelerator.

It is another object of the invention to provide a record medium for executing a method of operation optimization in a hardware graphics accelerator for the foregoing real-time rendering.

The invention is proposed to maintain operation continuance and minimize state variation during a process displaying 3-D objects on a computer screen using a hardware graphics accelerator, and enables a high screen display speed by analyzing material properties of the 3-D objects prior to screen display and grouping triangles composing the 3-D objects according to the same material property to produce triangle groups as many as the material properties; sorting and managing the triangles in each of the groups according to the distance from a camera; and extracting one triangle most distanced from the camera from the each of the groups at the point of screen display and finally selecting one triangle most distanced from the extracted triangles and outputting the same, in which the triangles are so controlled that another triangle extracted from the same group as the selected triangle is continuously outputted unless the another triangle does not overlap with the triangle extracted from other group even after the selected triangle is displayed.

The system and method of operation optimization in a hardware graphics accelerator for real-time rendering according to the invention to obtain the foregoing objects is characterized in maintaining operation continuance and minimizing state variation by analyzing all triangles composing 3-D objects according to the material property to produce groups prior to screen display; sorting the triangles in each of the groups according to the distance from the camera; and extracting one triangle from the each group at the point of screen display so that only one of the extracted triangles is selected and displayed on the screen, in which the triangles are controlled so that those triangles extracted from the same group can continuously selected.

According to an aspect of the invention to obtain the foregoing objects, a system for operation optimization in a hardware graphics accelerator for real-time rendering comprises: a hardware optimization pre-treatment unit for analyzing 3-D object geometric information to compose a material list, analyzing triangles composing 3-D objects, and producing triangle groups as many as the number of material properties when the 3-D object geometric information and material property information are inputted; a triangle sorting unit for sorting the material property-based triangle groups outputted from the hardware optimization pre-treatment unit according to camera information; and a triangle select/output unit for extracting the triangles by ones from the each of the sorted triangle groups, selecting triangles to be displayed from the extracted triangles, and outputting the selected triangles into a display device according to object type information.

Preferably, the hardware optimization pre-treatment unit comprises an object divider for providing the object type information into the triangle select/output unit by dividing the triangles in the material property-based triangle groups into opaque, transparent and translucent objects.

Preferably, the hardware optimization pre-treatment unit comprises: a material property analyzer for analyzing the 3-D object geometric information to extract only the material property information and composing the material list according to the extracted material property information; and a triangle grouping device for analyzing a plurality of triangles composing the 3-D object geometric information, grouping the analyzed triangles according to the material property information from the material property analyzer, and adding the grouped triangles to the corresponding material property-based triangle groups.

Preferably, the material property analyzer comprises: judgment means for referring to the material list composed up to the present that material property is analyzed about one object and judging whether the material property is already contained in the material list; and generator means for adding the material property of the one object into the material list and generating a new triangle group for managing triangles having the material property if the material property is not contained in the material list at present, wherein the generator means does not add the material property into the material list if the material property is already contained in the material list which is analyzed at present.

Also preferably, the triangle select/output unit comprises: a triangle extractor for primarily extracting one triangle most adjacent to or most distance from the camera from the triangles belonging to each of the triangle groups sorted by the triangle sorting unit to select triangles to be displayed on a screen of the display device; a first triangle selector for selecting a first triangle from the triangles extracted by the triangle extractor according to the camera information; a second triangle selector for selecting a second triangle having the same material property as the currently outputted triangle from the triangles extracted by the triangle extractor; and a triangle output device for (a) judging whether the first and second triangles respectively selected by the first and second triangle selectors overlap with each other on the screen after being displayed, and (b) outputting the second triangle into the display device if the selected first and second triangles do not overlap with each other and outputting the first triangle into the display device if the selected first and second triangles overlap with each other.

According to another aspect of the invention to obtain the foregoing objects, a method for operation optimization in a hardware graphics accelerator for real-time rendering comprises the following steps of: when 3-D object geometric information and material property information are inputted, (a) analyzing the 3-D object geometric information to compose a material list and analyzing triangles composing 3-D objects to produce triangle groups as many as the number of material properties; (b) sorting the material property-based triangle groups according to camera distance information; and (c) extracting the triangles by ones from the each of the sorted triangle groups, selecting triangles to be displayed from the extracted triangles and displaying the selected triangles via a display device according to object type information.

Preferably, the (c) step of displaying the selected triangles comprises: dividing the triangles in the material property-based triangle groups into opaque, transparent and translucent objects to display the triangles according to the divided object type.

Preferably, the (a) step of producing triangle groups comprises: (i) analyzing the 3-D object geometric information to extract only the material property information and composing the material list according to the extracted material property information; and (ii) analyzing a plurality of triangles composing the 3-D object geometric information, grouping the analyzed triangles according to the extracted material property information, and adding the grouped triangles to the corresponding material property-based triangle groups.

Preferably, the (i) step of composing the material list comprises: referring to the material list composed up to the present that material property is analyzed about one object and judging whether the material property is already contained in the material list; and adding the material property of the one object into the material list and generating a new triangle group for managing triangles having the material property if the material property is not contained in the material list at present, wherein the material property is not added into the material list if the material property is already contained in the material list which is analyzed at present.

Preferably, the (c) step of displaying the selected triangles comprises: executing a triangle selecting and outputting step twice to output the opaque objects in the first execution and to output the transparent or translucent objects in the second execution, in which the opaque objects are displayed in their orders of adjacency to the camera, and the transparent or translucent objects are displayed in their orders of distance from the camera.

Preferably, the (c) step of displaying the selected triangles comprises the steps of: primarily extracting one triangle most adjacent to or most distance from the camera from the triangles belonging to each of the sorted triangle groups to select triangles to be displayed on a screen of the display device; selecting a first triangle according to the camera information and a second triangle having the same material property as the currently outputted triangle from the extracted triangles, respectively; judging whether the first and second triangles respectively selected overlap with each other on the screen after being displayed; and if the selected first and second triangles do not overlap with each other, outputting the second triangle into the display device, and if the selected first and second triangles overlap with each other, outputting the first triangle into the display device.

According to still another aspect of the invention to obtain the foregoing objects, a record medium readable by a digital processing unit records a tangibly embodied program of instructions executable by the digital processing unit for carrying out a method for operation optimization in a hardware graphics accelerator for real-time rendering, wherein the program is executed in the following steps of: when 3-D object geometric information and material property information are inputted, (a) analyzing the 3-D object geometric information to compose a material list and analyzing triangles composing 3-D objects to produce triangle groups as many as the number of material properties; (b) sorting the material property-based triangle groups according to camera distance information to output each of the sorted triangle groups; and (c) extracting the triangles by ones from the each of the sorted triangle groups, selecting triangles to be displayed from the extracted triangles and displaying the selected triangles via a display device according to object type information, wherein the (c) step of displaying the selected triangles comprises the steps of: (i) primarily extracting one triangle most adjacent to or most distance from the camera from the triangles belonging to each of the sorted triangle groups to select triangles to be displayed on a screen of the display device; (ii) selecting a first triangle according to the camera information and a second triangle having the same material property as the currently outputted triangle from the extracted triangles, respectively; (iii) judging whether the first and second triangles respectively selected overlap with each other on the screen after being displayed; and (iv) if the selected first and second triangles do not overlap with each other, outputting the second triangle into the display device, and if the selected first and second triangles overlap with each other, outputting the first triangle into the display device.

In the invention having the foregoing characteristics, the material properties of the 3-D objects given prior to screen display are analyzed, the triangles composing the 3-D objects are grouped according to their material properties, and then the triangles are sorted according to the distance from the camera. When the 3-D objects are displayed on the screen, the opaque objects are primarily displayed and then the transparent or translucent objects are displayed according to the material properties. In order to produce a clear screen, the opaque objects are displayed in their order of adjacency to the camera and the transparent or translucent objects are displayed in their order of distance from the camera. Speed enhancement can be achieved in the hardware graphics accelerator by controlling the triangles so that the triangles having the same material property are outputted at the same time as many as possible.

For the purpose of this, the invention classifies the triangles according to their material properties dividing into the groups as many as the material properties, and sorts the triangles in the each group according to the distance from the camera. At the point of screen display, the triangle most adjacent to or most distanced from the camera is extracted from the each group, and one triangle selected from the extracted triangles according to the distance is displayed. Another triangle extracted from the same group as the selected triangle is continuously outputted unless the triangle does not overlap with the triangle extracted from other group even after the selected triangle is displayed. Then, the material property switching is minimized in the graphics accelerator while the clear screen display is maintained.

### BRIEF DESCRIPTION OF THE DRAWINGS

FIG. 1 illustrates a system structure for selecting a portion to be displayed on a screen from 3-D objects using LOD and culling techniques of the prior art;

FIG. 2A illustrates a detailed block and a treatment process about an LOD controller shown in FIG. 1;

FIG. 2B illustrates a detailed block and a treatment process about a culling controller shown in FIG. 1;

FIG. 3A is a conceptual view illustrating operation of a view frustum culling which is one of general culling techniques;

FIG. 3B is a conceptual view illustrating operation of a back-face culling which is one of general culling techniques;

FIG. 3C is a conceptual view illustrating operation of a hidden-surface culling which is one of general culling techniques;

FIG. 4 illustrates an operational structure of a system and method for operation optimization in a hardware graphics accelerator for real-time rendering of the invention,

FIG. 5 illustrates a detailed configuration and treatment process of a hardware optimization pre-treatment device shown in FIG. 4; and

FIG. 5B illustrates a detailed configuration and treatment process about a triangle select/output device shown in FIG. 4.

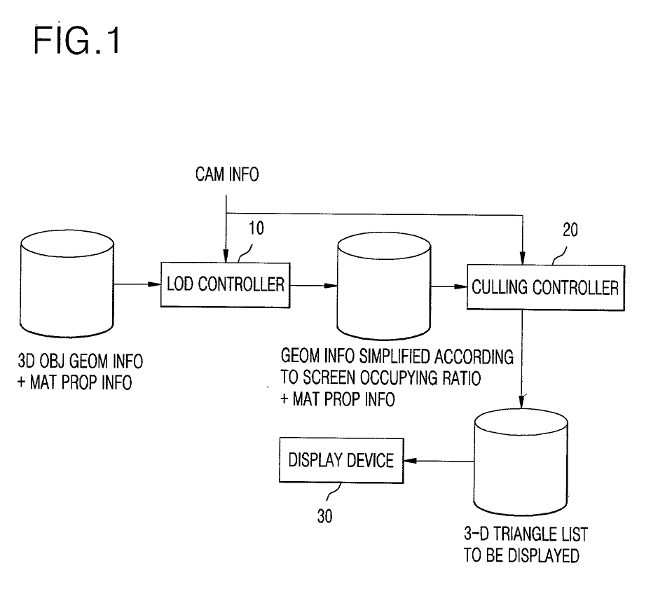

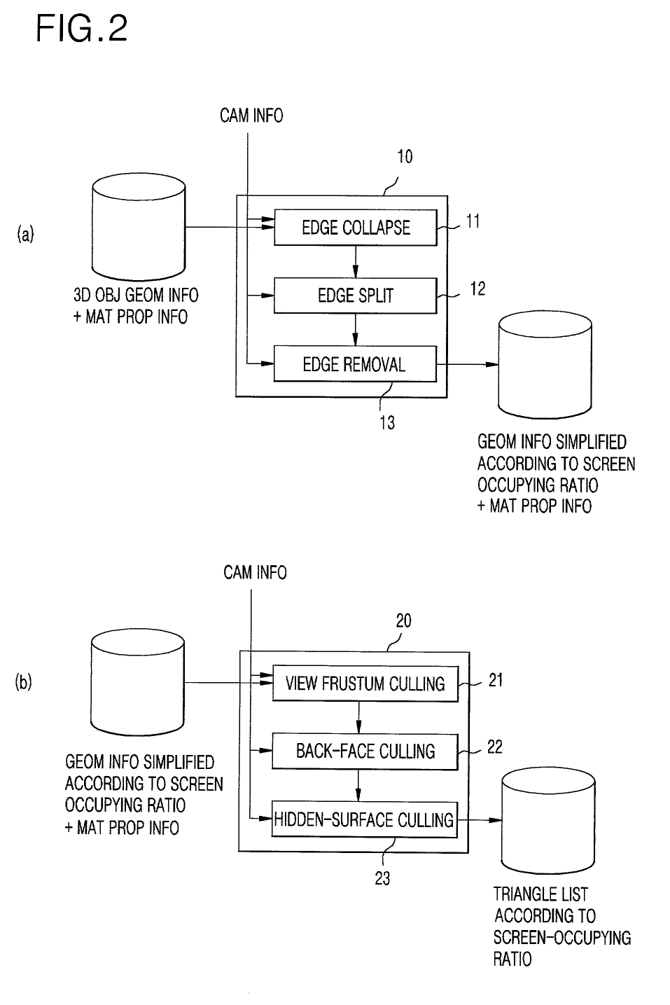

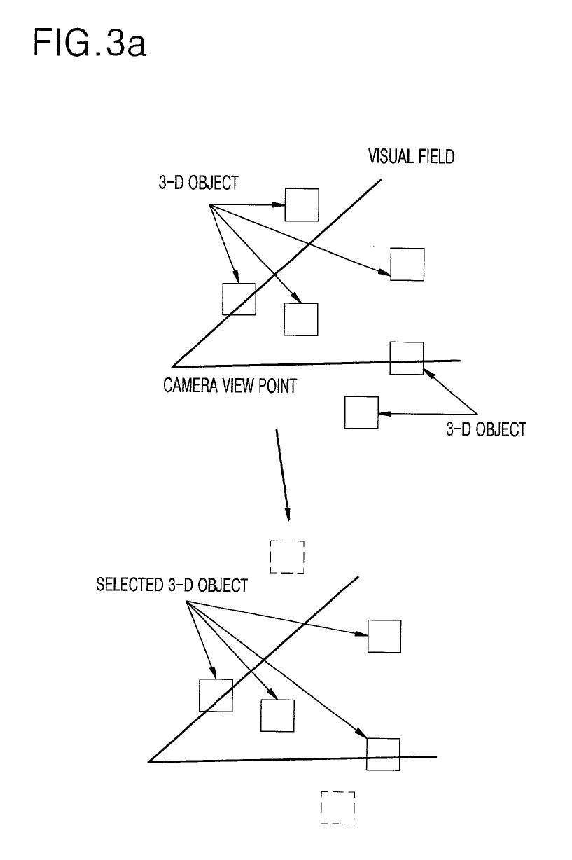

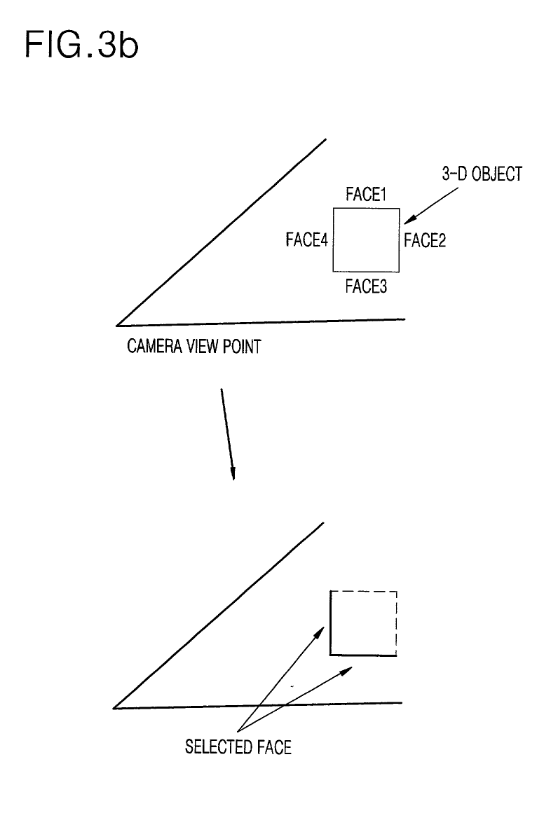

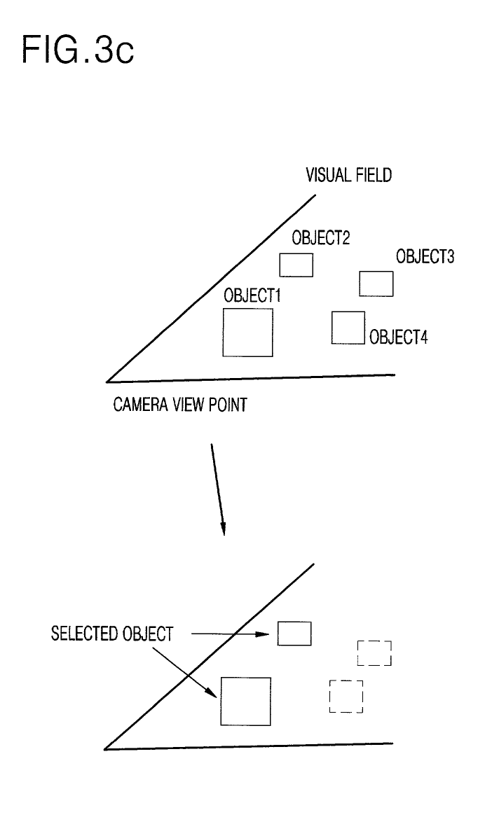

### DETAILED DESCRIPTION OF THE PREFERRED EMBODIMENT

The following detailed description will present an embodiment according to a system and method for operation optimization in a hardware graphics accelerator for real-time rendering in reference to the accompanying drawings.

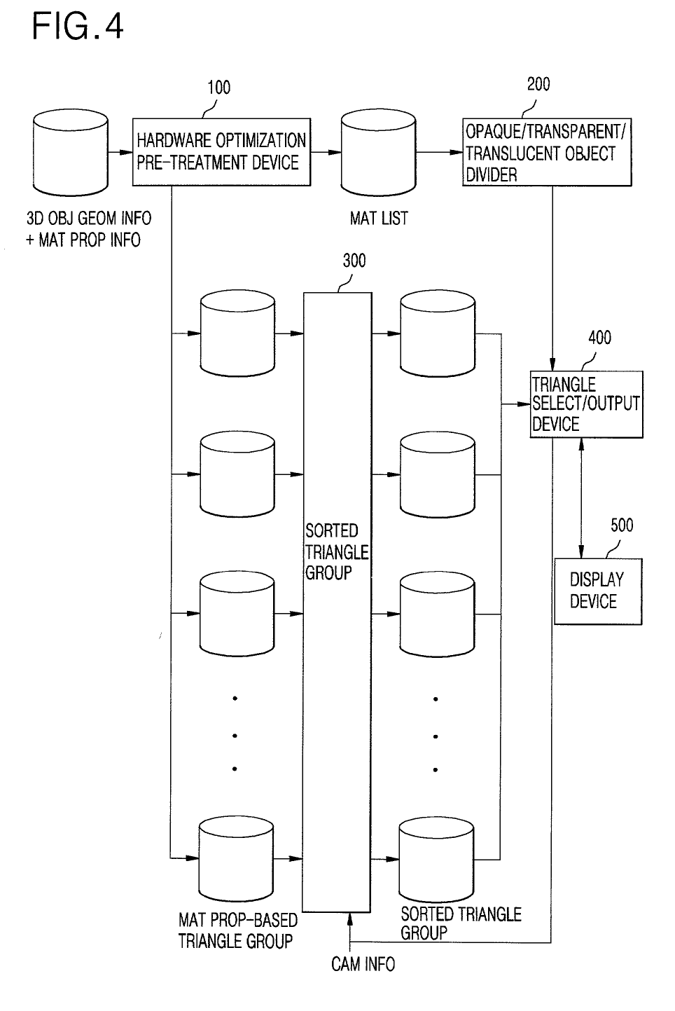

FIG. 4 illustrates a structure of a system for operation optimization in a hardware graphics accelerator for real-time rendering according to the invention, in which the system is comprised of a hardware optimization pre-treatment device 100, a divider 200 for opaque/transparent/translucent objects, a triangle sorting device 300, a triangle select/output device 400 and a display device 500.

When geometric information and material property information of given 3-D objects are inputted, the hardware optimization pre-treatment device 100 analyzes the geometric information to compose a material list, and analyzes triangles composing the 3-D objects to create triangle groups as many as material properties. Each of the triangles is included into each of the triangle groups.

The divider 200 for opaque/transparent/translucent objects divides triangle objects of the material property-based triangle groups, which are treated in the hardware optimization pre-treatment device 100, into opaque, transparent or translucent objects. The each divided opaque, transparent or translucent object is provided to the triangle select/output device 400.

The triangle sorting device 300 sorts the material property-based triangle groups which are outputted after treatment from the hardware optimization pre-treatment device 100 according to provided camera information, i.e. camera distance, and provides the sorted triangle groups to the triangle select/output device 400.

The triangle select/output device 400 outputs the triangles by ones from the each resultant triangle group before selecting object triangles to be displayed. The object triangles are outputted into the display device 500 and displayed on a screen thereby.

It will be described about detailed operations of the above structure.

In displaying 3-D objects on a computer screen using a hardware graphics accelerator, e.g. a hardware graphic acceleration board, the material properties of the given 3-D objects are inspected prior to display in order to enhance the display speed by optimizing the operation number or sequence in the graphics accelerator.

The triangles composing the 3-D objects are classified according to the same material property based upon the material property information of the 3-D objects inspected as above, and then managed as sorted according to the distance from a camera.

In displaying the 3-D objects, they are displayed according to the material property from opaque objects to transparent or translucent objects. For correct screen display, it is required that the opaque objects are displayed from those adjacent to the camera and the transparent or translucent objects are displayed from those distanced away from the camera. In order to enhance the speed in the hardware graphics accelerator, it is required to control the triangles with the same material property to be displayed as simultaneous as possible.

In other words, the triangles are divided into the groups as many as the material properties by grouping the triangles based upon the material property of the each group, and again the triangles in the each group are managed by sorting according to the distance from the camera.

On screen display, one of the triangles most adjacent to the camera or most distanced away from the camera is extracted from the each group, and then one of the extracted triangles is displayed after selected according to the distance from the camera. However, even after the currently selected triangle is outputted, another triangle extracted from the same group is outputted as long as it does not overlap with the previously extracted triangle, so as to minimize material property switching as well as maintain correct screen display and operation continuance in the graphics accelerator, thereby enhancing the operation speed of the graphics hardware accelerator.

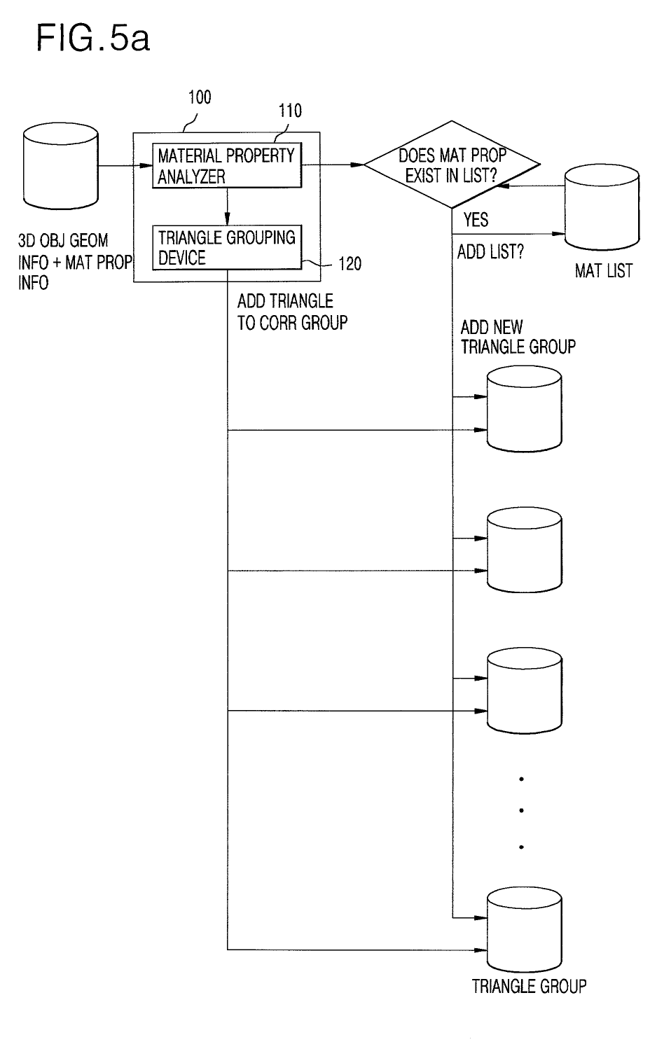

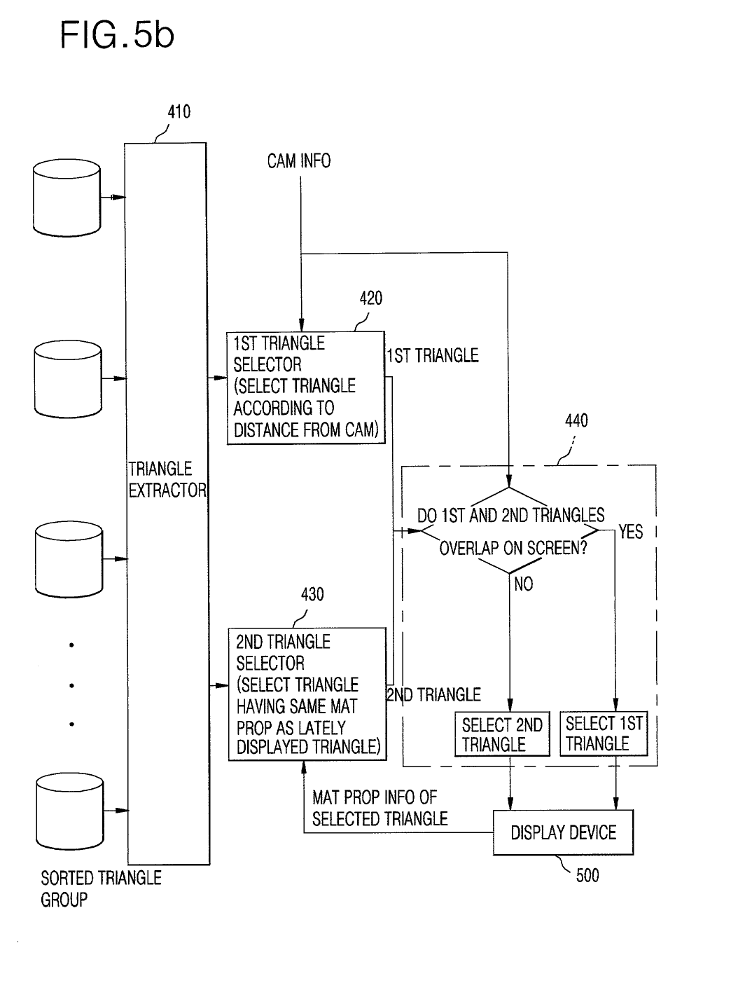

FIG. 5A illustrates a detailed configuration and treatment process of the hardware optimization pre-treatment device shown in FIG. 4, in which the geometric information given from the above technique is analyzed to compose the material list; the triangles composing the 3-D objects are analyzed to create the triangle groups as many as the material properties; and the triangles are respectively joined into the groups. The hardware optimization pre-treatment device 100 can be constituted of a material property analyzer 110 and a triangle grouping device 120.

In other words, the hardware optimization pre-treatment analyzer 100 performs two-step processes of analyzing the material property about the 3-D object geometric information given through the material property analyzer 110 and grouping the triangles through the triangle grouping device 120.

First, the process of analyzing the material properties in the material property analyzer 110 analyzes given object information to extract only material property information and composes the material list according to the extracted material property information. At one time point of analyzing the material property of one object, the material property analyzer 110 refers to the material list which is composed up to that point to judge whether the material property is already contained in the list.

If it is judged that the material property about the currently analyzed object is already contained in the list, the material property analyzer 110 controls so that the list is not updated with those material property in order to prevent unnecessary overlap of information. If the material property under analysis is not contained in the material list up to the present time point, the material property analyzer 110 updates the list to contain the material property and generates a new triangle group for managing the triangles having the new material property.

In the grouping process, the triangle grouping device 120 analyzes each of the triangles composing the 3-D objects, groups the triangles according to the material property, and adds the grouped triangles to the corresponding triangle groups.

FIG. 5B illustrates a detailed configuration and treatment process about the triangle select/output device shown in FIG. 4, in which the triangle select/output device 400 is constituted of a triangle extractor 410, the first and second triangle selectors 420 and 430 and a triangle output device 440.

First, the material property-based triangle groups processed through the hardware optimization pre-treatment device 100 shown in FIG. 4 are respectively sorted in the triangle sorting device 300 according to the provided camera information or camera distance.

The triangles are sorted based upon the distance from the camera in reference to the camera position at the point of display. The triangle extractor 410 shown in FIG. 5B primarily extracts the triangle most adjacent or distanced to/from the camera from the triangle groups sorted via such a sorting process. The opaque objects and the transparent or translucent objects should be separately treated as set forth above. Therefore, triangle selection and output steps are executed twice in order to display the opaque objects in the first execution and the transparent or translucent objects later in the second execution. Herein, the opaque objects are displayed primarily with those adjacent to the camera, whereas the transparent or translucent objects are displayed primarily with those distanced from the camera.

In other words, the triangle extractor 410 primarily extracts the triangle most adjacent to the camera or most distanced from the camera from the triangles belonging to the each triangle group in order to select object triangles to be displayed on a screen.

The first triangle selector 420 shown in FIG. 5B selects one triangle or the first triangle according to the camera information, i.e. the magnitude of the distance from the camera, from the extracted triangles.

Displaying the triangles in this manner, the standard of triangle selection is only the distance from the camera. This causes material property switching to frequently take place in the stage of triangle display, thereby slowing down the display speed. Therefore, this problem is solved using the second triangle selector 430 shown in FIG. 5B.

The second triangle selector 430 selects one triangle or the second triangle having the same material property as the lately displayed triangle from those triangles selected in the triangle groups each.

The first and second triangles respectively selected in the triangle selectors 420 and 430 are provided to the triangle output device 440.

The triangle output device 440 inspects whether the first and second triangles respectively selected in the triangle selectors 420 and 430 overlap with each other on the screen after being displayed.

As a result of inspection, if the first and second triangles do not overlap with each other on the screen, the second triangle having the same material property selected in the second triangle selector 430 is displayed via the display device 500.

However, if the first and second triangles overlap with each other on the screen, the first triangle selected in the first triangle selector 420 according to the distance from the camera is displayed via the display device 500.

The foregoing processes reduce the material property switching in the hardware graphics accelerator while maintaining triangle display format according to the distance magnitude from the camera as it is.

As described hereinbefore, the system and method for operation optimization in a hardware graphics accelerator for real-time rendering of the invention groups all of the triangles composing the 3-D objects to compose groups prior to screen display, sorts the triangles in the each group according to the distance from the camera, extracts the triangles by ones from the each group on screen display, and selects only one triangle from the extracted triangles to be displayed on the screen. Control is so executed that the triangle selected from the same group can be continuously selected, thereby maintaining operation continuance and minimizing state variation in the graphics accelerator.

This maintains the operation continuance and minimizes the state variation in the graphics accelerator which operates via a pipeline technique and with a separate internal operating device so that a Graphics Processing Unit (GPU) in the graphics accelerator can exert the maximum performance, thereby displaying the 3-D objects at a very high speed.

What is claimed is:

1. A system for operation optimization in a hardware graphics accelerator for real-time rendering, comprising:
a hardware optimization pre-treatment unit for analyzing 3-D object geometric information to compose a material list, analyzing triangles composing 3-D objects, and producing triangle groups as many as the number of material properties when the 3-D object geometric information and material property information are inputted;
a triangle sorting unit for sorting the material property-based triangle groups outputted from said hardware optimization pre-treatment unit according to camera information; and
a triangle select/output unit for extracting the triangles by ones from the each of the sorted triangle groups, selecting triangles to be displayed from the extracted triangles, and outputting the selected triangles into a display device according to object type information.

2. A system for operation optimization in a hardware graphics accelerator according to claim 1, further comprising an object divider for providing the object type information into said triangle select/output unit by dividing the triangles in the material property-based triangle groups into opaque, transparent and translucent objects.

3. A system for operation optimization in a hardware graphics accelerator according to claim 1, wherein the camera information is magnitude of camera distance.

4. A system for operation optimization in a hardware graphics accelerator according to claim 1, wherein said hardware optimization pre-treatment unit comprises:
a material property analyzer for analyzing the 3-D object geometric information to extract only the material property information and composing the material list according to the extracted material property information; and
a triangle grouping device for analyzing a plurality of triangles composing the 3-D object geometric information, grouping the analyzed triangles according to the material property information from said material property analyzer, and adding the grouped triangles to the corresponding material property-based triangle groups.

5. A system for operation optimization in a hardware graphics accelerator according to claim 1, wherein said material property analyzer comprises:
judgment means for referring to the material list composed up to the present that material property is analyzed about one object and judging whether the material property is already contained in the material list; and
generator means for adding the material property of the one object into the material list and generating a new triangle group for managing triangles having the material property if the material property is not contained in the material list at present, wherein said generator means does not add the material property into the material list if the material property is already contained in the material list which is analyzed at present.

6. A system for operation optimization in a hardware graphics accelerator according to claim 1, wherein said triangle select/output unit executes a triangle selecting and outputting step twice to output the opaque objects in the first execution and to output the transparent or translucent objects in the second execution.

7. A system for operation optimization in a hardware graphics accelerator according to claim 6, wherein said triangle select/output unit outputs the opaque objects in their orders of adjacency to the camera and outputs the transparent or translucent objects in their orders of distance from the camera.

8. A system for operation optimization in a hardware graphics accelerator according to claim 1, wherein said triangle select/output unit comprises:
a triangle extractor for primarily extracting one triangle most adjacent to or most distance from the camera from the triangles belonging to each of the triangle groups sorted by said triangle sorting unit to select triangles to be displayed on a screen of said display device;
a first triangle selector for selecting a first triangle from the triangles extracted by said triangle extractor according to the camera information;
a second triangle selector for selecting a second triangle having the same material property as the currently outputted triangle from the triangles extracted by said triangle extractor; and
a triangle output device for (a) judging whether the first and second triangles respectively selected by said first and second triangle selectors overlap with each other on the screen after being displayed, and (b) outputting the second triangle into the display device if the selected first and second triangles do not overlap with each other and outputting the first triangle into the display device if the selected first and second triangles overlap with each other.

9. A method for operation optimization in a hardware graphics accelerator for real-time rendering, said method comprising the following steps of:
when 3-D object geometric information and material property information are inputted,
(a) analyzing the 3-D object geometric information to compose a material list and analyzing triangles composing 3-D objects to produce triangle groups as many as the number of material properties;
(b) sorting the material property-based triangle groups according to camera distance information; and
(c) extracting the triangles by ones from the each of the sorted triangle groups, selecting triangles to be displayed from the extracted triangles and displaying the selected triangles via a display device according to object type information.

10. A method for operation optimization in a hardware graphics accelerator according to claim 9, wherein said (c) step of displaying the selected triangles comprises: dividing the triangles in the material property-based triangle groups into opaque, transparent and translucent objects to display the triangles according to the divided object type.

11. A method for operation optimization in a hardware graphics accelerator according to claim 9, wherein said (a) step of producing triangle groups comprises the steps of:
(i) analyzing the 3-D object geometric information to extract only the material property information and composing the material list according to the extracted material property information; and
(ii) analyzing a plurality of triangles composing the 3-D object geometric information, grouping the analyzed triangles according to the extracted material property information, and adding the grouped triangles to the corresponding material property-based triangle groups.

12. A method for operation optimization in a hardware graphics accelerator according to claim 11, wherein said (i) step of composing the material list comprises the steps of:
referring to the material list composed up to the present that material property is analyzed about one object and judging whether the material property is already contained in the material list; and
adding the material property of the one object into the material list and generating a new triangle group for managing triangles having the material property if the material property is not contained in the material list at present, wherein the material property is not added into the material list if the material property is already contained in the material list which is analyzed at present.

13. A method for operation optimization in a hardware graphics accelerator according to claim 9, wherein said (c) step of displaying the selected triangles comprises: executing a triangle selecting and outputting step twice to output the opaque objects in the first execution and to output the transparent or translucent objects in the second execution.

14. A method for operation optimization in a hardware graphics accelerator according to claim 13, wherein the opaque objects are displayed in their orders of adjacency to the camera, and the transparent or translucent objects are displayed in their orders of distance from the camera.

15. A method for operation optimization in a hardware graphics accelerator according to claim 9, wherein said (c) step of displaying the selected triangles comprises the steps of:
primarily extracting one triangle most adjacent to or most distance from the camera from the triangles belonging to each of the sorted triangle groups to select triangles to be displayed on a screen of the display device;
selecting a first triangle according to the camera information and a second triangle having the same material property as the currently outputted triangle from the extracted triangles, respectively;
judging whether the first and second triangles respectively selected overlap with each other on the screen after being displayed; and
if the selected first and second triangles do not overlap with each other, outputting the second triangle into the display device, and if the selected first and second triangles overlap with each other, outputting the first triangle into the display device.

16. A record medium readable by a digital processing unit, said record medium recording a tangibly embodied program of instructions executable by the digital processing unit for carrying out a method for operation optimization in a hardware graphics accelerator for real-time rendering, wherein the program is executed in the following steps of:
when 3-D object geometric information and material property information are inputted,
(a) analyzing the 3-D object geometric information to compose a material list and analyzing triangles composing 3-D objects to produce triangle groups as many as the number of material properties;
(b) sorting the material property-based triangle groups according to camera distance information to output each of the sorted triangle groups; and
(c) extracting the triangles by ones from the each of the sorted triangle groups, selecting triangles to be displayed from the extracted triangles and displaying the selected triangles via a display device according to object type information,
wherein said (c) step of displaying the selected triangles comprises the steps of:
(i) primarily extracting one triangle most adjacent to or most distance from the camera from the triangles belonging to each of the sorted triangle groups to select triangles to be displayed on a screen of the display device;
(ii) selecting a first triangle according to the camera information and a second triangle having the same material property as the currently outputted triangle from the extracted triangles, respectively;
(iii) judging whether the first and second triangles respectively selected overlap with each other on the screen after being displayed; and
(iv) if the selected first and second triangles do not overlap with each other, outputting the second triangle into the display device, and if the selected first and second triangles overlap with each other, outputting the first triangle into the display device.
